(19) United States
(12) Patent Application Publication
(10) Pub. No.: US 2009/0210304 A1
(43) Pub. Date: Aug. 20, 2009

(54) Behavioral reward based community accessible via media disc

(76) Inventor: E.M. Loveman, Miami, FL (US)

Correspondence Address: Laurence J. Edson, Esq., 2514 Hollywood Blvd., Ste. 300, Hollywood, FL, 33020, US

(21) Appl. No.: 12/069,980

(22) Filed: Feb. 15, 2008

(51) Int. Cl. G06Q 30/00; G06F 17/30

(52) U.S. Cl. 705/14; 707/104.1; 707/E17.001

(57) ABSTRACT

A personalized interactive media disc supported by a user-fan community having a media disc and an environment for a user to interact with other users as well as access and create data. The media disc is obtained by a user-fan via a licensed premium giveaway at a spectator event. The media disk allows a registered users to access an environment featuring other users and a plurality of databases. Promotional sponsors have specific access to the environment allowing them to maintain promotional events, retrieve demographic information, and to obtain various other user information for marketing purposes within the user community. The greatest access is available solely to the system administrator, including the ability to modify any aspect of the environment.

### BACKGROUND OF THE INVENTION

1. Introduction

Conventionally, an attendee at a spectator event will be given a premium give-away upon entrance to the event. At a football game, for example, the attendee might receive a toy football featuring the name of the home team and at least one sponsor's name or logo. Altruism aside, the sponsor expects the giveaway to serve as a promotional tool in a grander marketing scheme. Unfortunately, traditional premium give-away items have several limitations.

First the sponsor has no idea who is receiving the giveaway. Chances are that the spectator is a sports fan, but gender and age remain a mystery. The sponsor is uncertain as to its audience.

Second, the sponsor has no idea if the recipient will keep the item beyond game day. The premium giveaway might be discarded immediately. The sponsor cannot specifically and reliably know the impact of its marketing effort.

Finally, the sponsor does not have a means of effectively integrating the premium giveaway into the sponsor's grander marketing scheme. Cross marketing undoubtedly exists between the sponsor and the event, but promotional impact is not necessarily increased within the sponsor's organization. The sponsor might have a sweepstakes program or offer discount coupons to tie-in with the premium giveaway. Unfortunately, there is no means to tie-in such programs with the premium giveaway.

One approach to solving these problems is to place the sponsor's URL address upon the premium give-away. The advent of the Internet and its present and increasing ubiquity allow an attendee to communicate with the sponsor. But, this approach leaves too much responsibility with the attendee.

2. Field of the Invention

The present invention relates to a method of promotion based upon a personalized interactive media disc as a premium giveaway at a spectator event and the user community created via use of the media disc.

3. Description of the Prior Art

Personalized interactive media disc user community interface have not been disclosed in U.S. Patents. However, electronic methods of obtaining, storing and analyzing data have been disclosed in U.S. Patents.

U.S. Pat. No. 6,799,271 B2 to Kugai teaches a Method and System for Authenticating User and Providing Service.

U.S. Pat. No. 6,993,500 B2 to Ishihara teaches a System and Method for Electronic Business Transaction of Trading Cards.

U.S. Pat. No. 7,054,842 B2 to James, et al. is a patent directed toward Stored Value Cards and Methods of their Issuance.

U.S. Pat. No. 7,055,031 B2 to Platt teaches a Method for Generation, Delivery and Validation of Electronic Coupons through Personal TV Service System.

### BRIEF SUMMARY OF THE INVENTION

It is an object of the present invention to provide a method of promotion via a premium giveaway.

Another object of the present invention is to provide a method for creation of a user community allowing sponsors to market their products and/or services to members of the user community.

A further object of the present invention is to provide the sponsors of spectator events with demographic data pertaining to the recipients of premium giveaways.

A further object of the present invention is to provide an incentive for the recipient of a premium giveaway to keep the giveaway for an extended period of time.

Yet another object of the present invention is to provide a means of integrating the giveaway into other aspects of a sponsor's marketing scheme; such as contests and discount coupons.

These and other objects of the invention are accomplished by providing a mini CD disc with media content, given to a spectator upon that spectator's attendance at a spectator event. When the user's computer reads the disc, the disc prompts a user to register the user's demographic data. The demographic data is transmitted to a demographic database, and should the data meet certain criteria, valuable offers are transmitted to the user. The media on the disc pertains to video, pictures and text having entertainment and educational value. The media encourages the user to continually use the disc, thereby allowing the sponsor to maintain contact with the user.

Other objects and further scope of applicability of the present invention will become apparent from the detailed description given hereinafter. However, it should be understood, that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE SEVERAL VIEWS OF THE DRAWING

The present invention will be better understood from the detailed description given herein below and the accompanying drawings with which are given by way of illustration only.

FIG. 1 is a view of the media disc and its storage sleeve for the present invention.

FIG. 2a is a schematic diagram illustrating the operations of the media disc of the present invention.

FIG. 2b is a schematic diagram illustrating the operations of the developer and sponsor maintained environments of the present invention.

FIG. 3a is a view the graphical interface for the present invention, with a football skin.

FIG. 3b is a view of the of the graphical interface for the present invention with the menu extended, for the basketball skin.

FIG. 3c is a view of sport specific (basketball and football) graphical interfaces for the present invention.

### DETAILED DESCRIPTION OF THE INVENTION

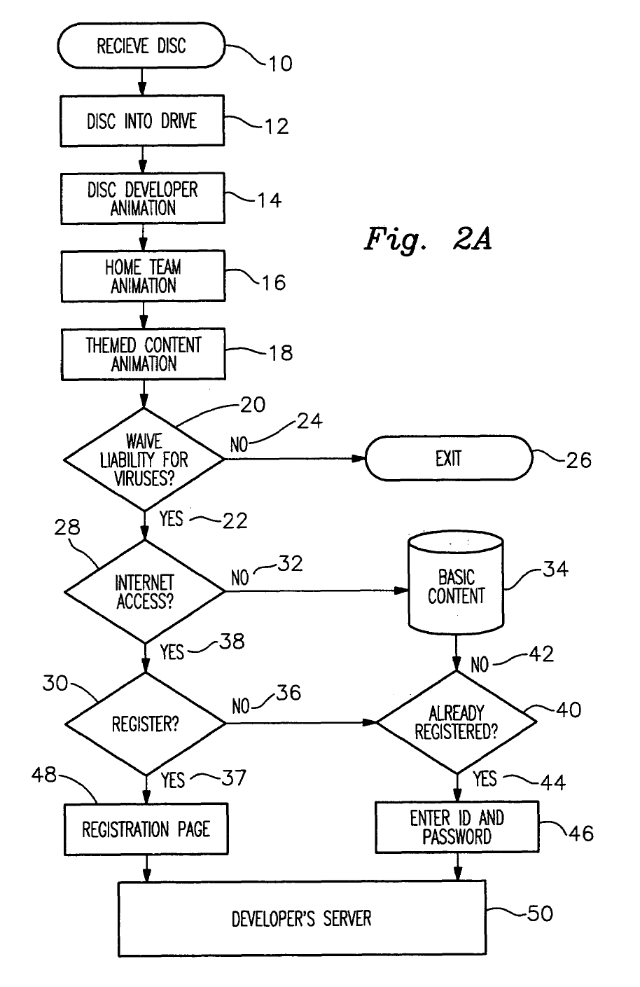

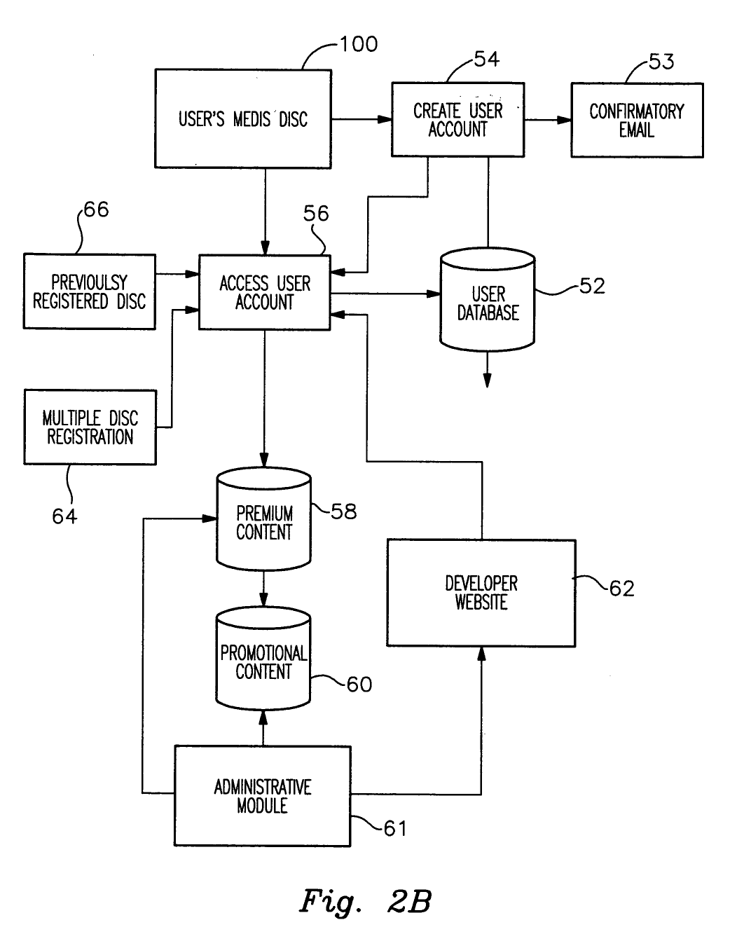

A method for creating a user community based upon a personalized interactive media disc is illustrated in FIGS. 2a and 2b. Here, one sees a sponsor ad-supported multimedia social networking and entertainment platform for sports fans.

Marketing for the platform is achieved by means of event-specific giveaways at sporting venues. When a spectator enters a spectator event, such as a football game, he or she receives 10 a mini CD disc, also referred to as a media disc, containing commonly themed media content, such as a particularly great game, or a celebrated former player. Basic flash-content on the media disc is available for offline viewing and includes event related statistics, video, slide show, and sponsor logos.

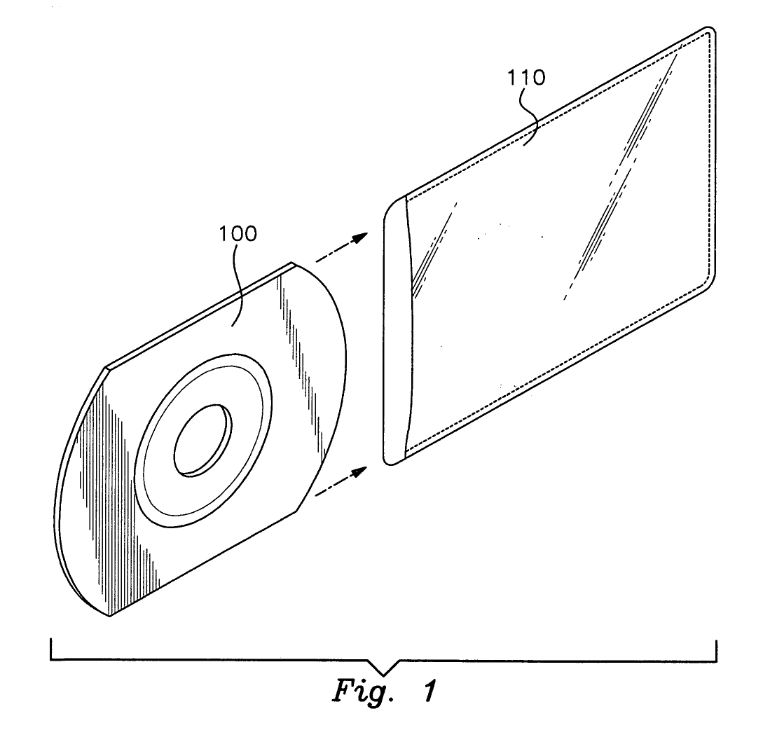

The media-disc 100, with its storage sleeve 110, is illustrated in FIG. 1. A sponsor, such as a cola beverage company or a fast food restaurant, typically bears the expense of providing the media discs. The media disc 100 might have labeling pertaining to the sponsor, the home sports team, and/or the featured content of the media disc.

When the spectator accesses to a personal computer, he or she, can insert the media disc 100 into the disc drive 12. At this point, we now refer to the individual with the disc as a disc user.

Once the user runs the initial program on the disc, the user is presented with various animation sequences and a corresponding soundtrack. FIG. 2a shows the portions of the presently claimed invention that are found and occur on the user's computer. First, appears a disc developer animation sequence 14 for the disc developer. Next, appears an animation sequence pertaining to the home sports team (a home team animation sequence 16), and in some embodiments the themed content of the disc (a themed content animation 18). These animation sequences are stored on the media disc 100.

The first prompt a user sees is a disclaimer concerning viruses on the disc. A waive liability for computer virus decision 20 is stored on the media disc 100. A user must choose either a “yes” waive liability 22 or “no” do not waive liability 24. Choosing “no” exits 26 the media disc and terminates the program. If a user waives liability, electing “yes”, he or she is allowed to continue to the next screen.

The next screen presented to the user is a registration page 30. Registration requires access to the Internet. An Internet access process 28 checks if the user's computer has Internet access. Should the disc fail to detect an Internet connection the program will prompt the user to either obtain a connection, or receive limited access to the themed content on the disc. Ultimately, failure to detect Internet access 32 directs the user to a basic content database 34. In any event, the user has the option of not registering 36 and remaining a guest with access limited to basic content, such as basic flash content available for offline viewing. The basic content database 34 is stored on the media disc 100. Internet access allows the user via the media disc to communicate with a developer's server.

Upon detecting Internet access, a registration decision prompts a user to choose from “yes” register disc,37 and a “no” do not register 36 options. An existing registered user decision 40 prompts upon choosing the “no” do not register disc option 36. The existing user decision 40 has a “yes” existing user 44 and a “no” not existing member 42 option. Choosing the “no” not an existing member option 42 directs the user to the basic content database 34.

The registration page 48 requires a user to enter his or her name, email address, date of birth, City and State. The user also must designate a user name and a user password. Once a user has entered this data, the data is transmitted to and stored in a user database 52 on the developer's server 50.

With reference to FIG. 2b, a create user account process 54 assigns an ID and password to the user's personal data fields. As mentioned above, the user's ID, password and personal data fields are stored in the user database 52 located on the developer's server 50.

An enter ID and password page 46 prompts upon the user choosing the “yes” existing user option 44 from the existing user decision. A user enters his or her ID and password. An access user account process retrieves the personal data fields assigned to the user's ID and password. The access user account process 56 initiates following entry of ID and password on the enter ID and password page.

Registering designates a user as a premium user with access to a premium content database 58. The disc 100 links to related premium content requires an Internet connection. The premium content database 58 is stored on the developer's server 50. Premium content includes features designed to retain and build membership including streaming vides, games, contests, user-generated blogs and discussion boards, friends-list, messing, chat rooms, scoreboards, polls, and news.

A promotional program database 60 is stored on the developer's server 50. The promotional program database 60 is accessible following retrieval of the personal data fields assigned to the user's ID and password via the premium content database 58. The promotional program database 58 features data on contest or coupons and the user data requirements for eligibility.

Further, a developer website 62, in addition to providing general information concerning the developer's company and product, allows registered users to access premium content with one's user name and password. Thus, allowing access without physical possession of the media disc. This feature overcomes the problems presented by damaged, lost, or given away discs. The developer website 62 also has a logon page, whereby a user ID and password can be entered to access the user's account in the user database 52. A developer information page shows the developer's biographically information, including the developer's product and company might be accessed and displayed.

Users might register multiple discs. Should a user log on with an existing ID and password using a new disc, the new disc becomes linked to the existing profile.

A multiple disc registration prompt 64 appears when the access user account process 56 retrieves at least one registered media disc data set in the user database 52 for the user. The multiple disc registration prompt 64 has “yes” register multiple disc and “no” do not register multiple disc options. Choosing the “yes” register multiple disc option adds disc registration information to the user database 52, allowing premium access, and the “no” do not register multiple disc option directs the user to the basic content database 34.

Multiple-users might register using the same disc. If an original user gives a disc to a friend, the friend might register and enter premium areas of the developer's website with his own ID and password. The original user does not lose the ability to enter the website, however his entry is through the generic skin of the disc developer's website.

A previously registered disc prompt 66 appears when the access user account process 56 retrieves a previously registered media disc data set in another user database. The previously registered disc prompt 56 has “yes” register previously registered disc and “no” do not register previously registered options. Choosing the “yes” register previously registered option allows the creation of the user's disc registration information and storage in the user database 52, allowing premium access. The “no” do not register previously registered option directs the user to the basic content database 34.

Upon completion of registration, in one preferred embodiment, a confirmatory email 53 is sent to the user welcoming the user to the disc community.

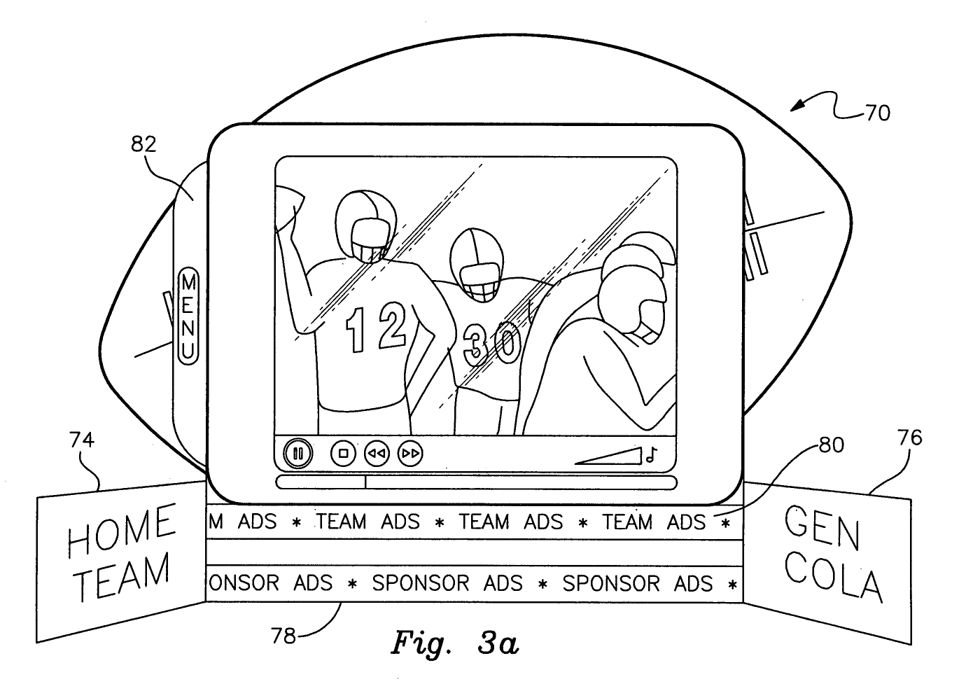

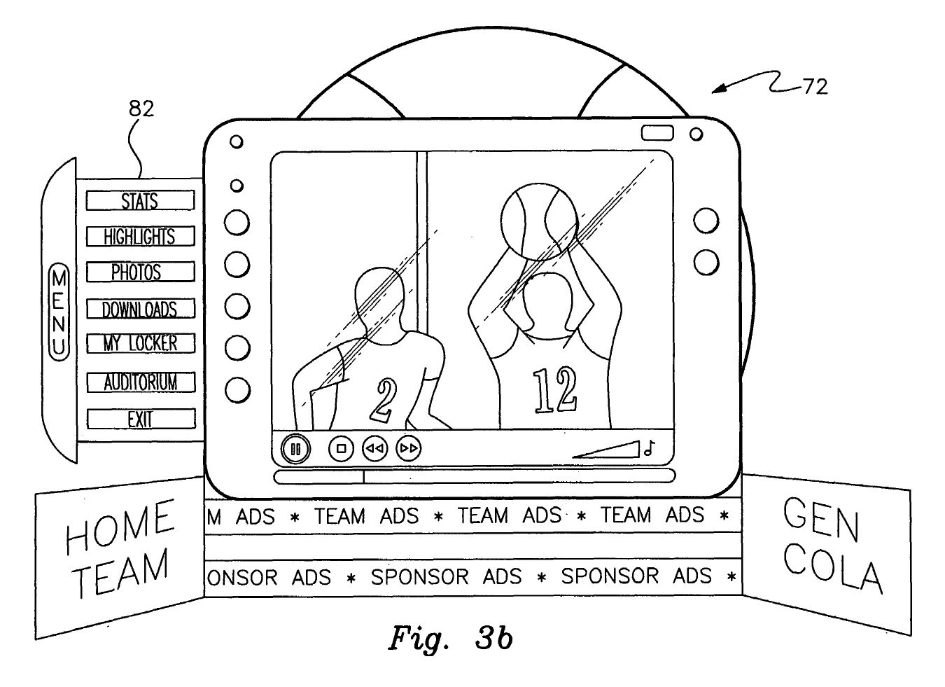

A user is presented with a media disc skin 70, as illustrated in FIG. 3a. Skins serve as a graphical interface to the basic 34 and premium content 58 databases. The skin 70 appears when the Internet access process 28 fails to detect Internet access 32, the access user account process retrieves the user ID and password, or the user chooses “no” do not register disc option 42 of the registration decision. Skins 70 are decorated to suggest the particular sport featured at an event. FIG. 3c shows two different sport specific skins for football 70 and basketball 72.

The skin 70 has at least two logos, the team logo 74, and at least one sponsor logo 76. A preferred embodiment features logos for multiple sponsors. Tapping on those logos will direct the user to a designated website for that logo. The designated website might be for retail sale of the team's clothing or the sponsor's main commercial portal.

The skin 70 also features at least two lines of steaming text or “crawlers.” The content of one of the crawlers pertains to the sport team 80, and the other crawler to a least one of the sponsors 78. The content is selected based upon the user's demographic information, thus a user must be registered and have an Internet connection to receive crawler data. The crawler data pertains to promotional programs such as contests or coupons.

The skin 70 has a menu 82 that slides out when tapped with a cursor. This is illustrated in FIG. 3b. The sliding menu 82 lists basic and premium categories. The sliding menu 82 slides out when a user taps a menu bar with a cursor. Selecting a premium category, without premium access, prompts a user to register or obtain Internet access.

The menu items might include the following: Historic Game Statistics, Game Highlights Video, Game Photos, Downloads, Chat, Game Room, My Locker, Auditorium and Exit. Registered users have access to all of these menu items. Unregistered users, or those without an Internet connection can only access some of those menu items.

The basic content (unregistered.) buttons are listed first, followed by premium content (registered) buttons. Premium content buttons prompt for login with a link to registration page for unregistered users.

Basic content includes: Historic Game Statistics, Game Highlights Video, Game Photos and Downloads.

Historic game statistics includes information pertaining to the team and the sport.

Game Highlights Video includes video clips for the team and the sport. The video player has a volume rocker, play/pause button, fast forward, and fast reverse. The user can expand the video screen, but only large enough so that it does not cover the main template and crawlers. The screen returns to normal size at the end of the video.

Game Photos feature a slide show from previous games. The slide show might also feature an original or fight song music. After viewing a predetermined number of slides, a sponsor logo is inserted into the slide show. Slides might be downloaded onto user's own storage media for high quality printing. A line of text alerts the user to upcoming games or events. The user can expand the slide show screen, but only large enough so that it does not cover the main template and crawlers. The screen returns to normal size at the end of the slide show.

Downloads include wallpaper and screensaver downloads. The user downloads this content to his computer.

Premium content includes: Chat, Game Room, MyLocker, and Auditorium.

Chat includes virtual rooms that are sport specific with one room per sport.

The Game Room includes sport games and trivia contests in which users compete for sponsor's prizes.

The profile section might generally be referred to as “My Locker,” thus drawing a sports analogy to a disc user's personalized space.

The “My Locker (Profile Section)” ties all components of the media disc together. “My Locker,” like Facebook and MySpace is a social type of community, but unlike current social communities, “My Locker” creates an online community of media disc users. A number of events take place in “My Locker.”

The registered disc user initially sets up a social profile along with a picture. Privacy controls allow the disc user to set in order to let those other disc users either see a full profile of that disc user, or bits and pieces as the disc user sees fit.

The disc user searches (via a proprietary search engine) for more buddy disc users, invites new disc users, or ask other existing disc users to either join the disc user's “Disc User Club (or Buddy list)” or ask to join another disc user's “Disc User Club.”

There is an automatic default to privacy for users 17 and under. Entry to a Disc User Club requires permission, and certain areas of their profile will be private for users over 17.

The disc user posts pictures and create picture albums.

The disc user posts his own blog (online diary), and that blog is visible to his Disc User Club and vice versa (the disc user can see the blogs of members of their disc user club).

The disc user creates forums.

The disc user sends and receives Instant Message (IM's) with other disc users.

Each disc user has a disc user Mail (e-mail) account within “My Locker.” “My Locker” receives RSS Feeds of up to the minute Sports Stories, and Live Sports Scores of all sporting events. Disc users participate in custom designed interactive games with each other for prizes and points. Disc users participate in Sports Trivia Contests for prizes and points.

Disc users have a point bank in “My Locker” to accumulate points for certain designated behaviors, as previously mentioned and further explained below. This is a point accumulation program. The program primarily resides in three databases: a points bank, a credit points, and a debit points database.

The points bank is stored in the user database on the developer's server. The points bank is credited or debited with points based on the user's activities within the environment.

A credit points database is stored in the premium content database. A user's point bank is credited, or added to, for a predetermined number of points for the following: adding disc users to Disc User Club, posting a blog, creating a forum, posting pictures, winning a game, placing in the top three of game leaders per game, letting a friend use your Media disc to become a registered Disc user, participating in a poll, creating a social profile, logon and randomly awarded, tapping and printing a coupon from a sponsor's crawler, and tapping on a URL link of a sponsor.

The debit points database is stored in the premium content database. A user's point bank is debited, or subtracted from, for a predetermined number of points for entering weekly, monthly and yearend lotteries.

Disc users participate in all varieties of sport chats (all sports).

Daily polls from the Auditorium are accessible through “My Locker.”

There is a report abuse button in “My Locker.”

There is a Contact ACI link in “My Locker.”

There is a frequently asked question (FAQ) section in “My Locker.”

Above, are examples of activities that disc users participate in, but there are more capabilities of “My Locker.” For example, disc users can post videos. In one preferred embodiment, “My Locker” is OPEN SOURCE, meaning that disc users that know how to write programs can post different applications to “My Locker” that is available for other “disc users” to use and play with. This substantially increases the activities available to the disc user.

Disc users within “My Locker” are rewarded with points to accumulate in their point bank for certain behaviors. By awarding points for behaviors, disc users can purchase entries in the prize lotteries held daily, weekly, monthly, and at yearend. By registering the media disc initially, the disc user will get an entry in to each of the three main lotteries (weekly, monthly, and year end). And with two logins per day, the disc user will be awarded with two entries in to each of the three lottery drawings. Of course the disc user can log in unlimited numbers of times per day, but can only receive a maximum of two entries for each lottery per day. Disc users can also accumulate points that can be used to purchase entries in to disc user-designated lotteries. Examples of behaviors for earning points are listed below.

Each behavior has a finite number of times it will earn points per day (specified in the FAQ section of “My Locker”). These include, but are not limited to: (1) Add disc users to Disc User Club; (2) Post blog; (3) Create a forum; (4) Post pictures (5) Win a game; (6) Place in the top three of game leaders per game; (7) Let a friend use your Media disc to become a registered Disc user; (8) Participate in a poll; (9) Create a profile; (10) Lucky random login entry; (11) Click and print a coupon from a sponsor crawler; and (12) Click on a URL link of a sponsor. These are just some of the behaviors that disc users can use to earn points in their point banks.

Now take for instance that a sponsor provides the developer with fifty units of an item to use as prizes for the disc users. Those fifty units will be in one of the weekly drawings. If a disc user is motivated to win one of these prize units, then the more entries he/she can purchase for the drawing, the better chance they will be one of the fifty lottery winners.

One can be assured to do as many of the behaviors as possible to earn points to purchase drawings in that lottery. This goes the same with monthly drawings or the yearend drawing. Behaviors earn points that can purchase lottery drawings (i.e. fifty points buys one drawing).

Remember, with two logins per day, the disc user gets an entry (not points—this is the only behavior that earns entries—the other behaviors earn points) in each of the three lotteries.

In summation, the longer the disc users remain on the media disc, the longer the presenting game day sponsors and teams can communicate with the disc user via live text crawlers (info casts). This, of course drives the revenue of the disc developer. The team and sponsor receive lots of demographic information pertaining to their customers (disc users), and can communicate at will with those customers (disc users).

The crawlers will be visible to disc users within every page of the media disc and “My Locker” for the length of the promotion, and the Sponsor and Team URL's and logos will last for the life for the media disc.

Finally, within the pages of “My Locker,” the disc developer can sell display URL logos to other advertisers (similar to Google, Yahoo, etc.). These ads will rotate throughout “My Locker,” and are contracted on a monthly, or longer basis. With term advertising, the client can change their URL Logo once a month. With only a one-month contract, the URL Logo cannot be changed.

The Auditorium is a commons for disc users. All media discs navigate to the Auditorium. The Auditorium has prize drawings and content that is available to all premium users. Other features include: video-cast, celebrity chat, and daily polls.

Authorized users have the ability to create accounts and grant permission for access to Administrative Module functions 61. Account types include the developer and the sponsor.

Administrative Module functions 61 allow campaign management. Authorized Administrative module users have the ability to create, update, and delete campaign information.

Administrative Module functions 61 allow content creation and maintenance. Authorized Administrative module users have the ability to create, update, and delete content for the platform. This content includes, but is not limited to logos, crawlers, surveys, banner ads, animation, photos, downloads, and videos.

Administrative Module functions 61 allow rewards management. Authorized Administrative module users have the ability to create, update, and delete contest, prize, game, registration, and other reward information.

Reward behaviors are actions that trigger rewards. Behavior is first identified: registration, logon, contest winner, game high score, etc. Next, rewards are. identified: entry in year-end grand prize, entry in weekly prize drawing, etc. Then, prizes are identified. Finally, method of delivery is specified: email, or postal shipping, for example.

Prize notification includes: registration reminders, e-mail notification, winner notification (via FanMail), and prize notices.

Reporting demographic and other data. Information is collected during disc registration. This provides the developer and sponsors with useful information. Other data includes game and contest results, and user traffic. This data is gleaned as the media disc is used.

Administrative Module functions 61 allow content management of the developer website. Authorized Administrative module users have the ability to create, update, and delete content on the developer website that is subject to change.

The invention being thus described, it will be obvious that the same may be varied in many ways. Such variations are not to be regarded as a departure from the spirit and scope of the invention, and all such modifications are intended to be included within the scope of the following claims.

What is claimed is:

1. A personalized interactive media disc for media storage and user access to an environment for data compilation and retrieval comprising:
a media disc;
a basic content database stored on the media disc;
a disc developer animation sequence stored on the media disc and displays when a user inserts the media disc into the user's computer;
a home team animation sequence stored on the media disc and displays following the developer animation;
a themed content animation stored on the media disc and displayed following the team animation;
a waive liability for computer viruses decision stored on the media disc prompted following the display of the developer, team, and themed animations, the liability decision having “yes” waive liability and “no” do not waive liability options, wherein deciding the “no” do not waive liability option exits the media disc;
an Internet access process stored on the media disc for checking if the user's computer has Internet access, whereby failure to detect Internet access directs the user to the basic content database;
a registration decision for the media disc on the media disc prompted upon the Internet access process detecting Internet access, and having “yes” register disc and “no” do not register disc options;
an existing registered user decision prompted upon choosing the “no” do not register disc option, the existing user decision having “yes” existing user and “no” not existing member options, whereby choosing the “no” not an existing member option directs the user to the basic content database;
a registration page having personal data fields for entering data pertaining to the user, the registration page prompted upon choosing the “yes” register disc option for the registration decision;
a developer's server;
a create user account process for assigning an ID and password to the user's personal data fields and storing the ID, password and personal data fields in a user database located on the developer's server;
an enter ID and password page prompted upon choosing the “yes” existing user option of the existing user decision, whereby a user enters the ID and password;
an access user account process for retrieving the personal data fields assigned to the user's ID and password, the access user account process initiated following entry of the ID and password on the enter ID and password page;
a premium content database stored on the developer's server, the premium content database accessible following retrieval of the personal data fields assigned to the user's ID and password; and
a promotional program database stored on the developer's server, the promotional program database accessible following retrieval of the personal data fields assigned to the user's ID and password via the premium content database, the promotional program database having data on contest or coupons and the user data requirements for eligibility.

2. The media disc and environment of claim 1, further comprising:
a multiple disc registration decision prompts when the access user account process retrieves at least one registered media disc data set in the user database for the user, the multiple disc registration prompt having “yes” register multiple disc and “no” do not register multiple disc options, whereby choosing the “yes” register multiple disc option adds disc registration information to the user database, allowing premium access, and the “no” do not register multiple disc option directs the user to the basic content database; and
a previously registered disc prompt appearing when the access user account process retrieves a previously registered media disc data set in the user database, the previously registered disc prompt having “yes” register previously registered disc and “no” do not register previously registered options, whereby choosing the “yes” register previously registered option allows the creation of the user's disc registration information and storage in the user database, allowing premium access, and the “no” do not register previously registered option directs the user to the basic content database.

3. The media disc and environment of claim 1, the basic content database having basic sections including:
an historic game statistics section, pertaining to a team and a sport;
a game highlights video section, having video clips for the team and the sport;
a game photos section, having a slide show of pictures from previous games, pictures of a sponsor's logo, a line of text alerting user to upcoming games or events, and a soundtrack to accompany the slide show; and
a downloads section, including desktop wallpaper designs and screensavers.

4. The media disc and environment of claim 1, the premium database having premium sections including:
a chat forum section, including virtual sport specific rooms with one room per sport, allowing users to communicate with one another;
a game room section, including sports games and trivia contests, in which users compete for sponsor's prizes;
a My Locker section, having a user's social profile with picture, privacy controls allowing the user to specify who may see the user's social profile, and how much of profile is to be seen by others, a buddy search engine to find others online and accept or request joining a “Disc User Club”, an under 17 user automatic privacy default, a section for posting pictures and creating picture albums, a blog viewable by members of a user's Disc User Club, user created and maintained forums, instant messaging (IM) to other disc users, a Fan Mail account for receiving email, an RSS feed for currently sporting news, a point bank for accumulating points based on participation in a point accumulating program, a daily poll for user participation, a report abuse button for reporting abuses by other users, a contact developer button, a frequently asked question (FAQ) section, a post video section, a post downloadable user created software section; and
an Auditorium for allowing access to a user commons, whereby the user can enter prize drawings and view content available to all registered users.

5. The media disc and environment of claim 4, the point accumulation program having:
a points bank database stored in the user database, whereby the points bank is credited or debited with points based on the user's activities within the environment;
a credit points database in the premium content database, whereby a user's point bank is credited for a predetermined number of points for adding disc users to Disc User Club, posting a blog, creating a forum, posting pictures, winning a game, placing in the top three of game leaders per game, letting a friend use your Media disc to become a registered Disc user, participating in a poll, creating a social profile, logon and randomly awarded, tapping and printing a coupon from a sponsor's crawler, and tapping on a URL link of a sponsor; and
a debit points database in the premium content database, whereby a user's point bank database is debited for a predetermined number of points for entering weekly, monthly and yearend lotteries.

6. The media disc and environment of claim 1, the registration page having data fields for the user's name, email address, date of birth, preferred ID, preferred password, City and State.

7. The media disc and environment of claim 1, further comprising a media disc skin as a graphical interface to the basic and premium content databases, whereby the skin appears when the Internet access process fails to detect Internet access, the access user account process retrieves the user ID and password, or the user chooses “no” do not register disc option of the registration decision.

8. The media disc and environment of claim 7, wherein the media disc skin further comprises:
a sliding menu listing basic and premium categories, whereby the sliding menu slides out when a user taps a menu bar with a cursor, and selecting a premium category without premium access prompts a user to register or obtain Internet access;
at least two logos, the team and sponsor logo, whereby when a user taps the logo with a cursor, the user is directed to the designated website for the logo;
at least two lines of streaming text crawlers, the crawlers pertaining to a sponsor or the team, wherein the content of the text crawlers is selected by comparing the user's personal data fields to selection criteria stored in the promotional database.

9. The media disc and environment of claim 6, wherein the media disc skin is decorated to suggest a particular sport.

10. The media disc and environment of claim 1, further comprising a confirmatory email, wherein the email is sent to user following the create user account process.

11. The media disc and environment of claim 1, further comprising a developer website having:
a logon page, whereby a user ID and password can be entered to access the user's account in the user database; and
at least one developer information page, whereby the developer's biographically information, including the developer's product and company might be accessed and displayed.

12. The media disc and environment of claim 1, further comprising an administrative module having:
a modify developers website page, whereby the developer can modify the developer's website to create, change, or delete website content;
a modify promotions page, whereby a sponsor can modify the promotional database to create, change, or delete promotions;
a modify credit points database page, whereby a sponsor can modify the credit points database to create, change, or delete credit points;
a modify debit points database page, whereby a sponsor can modify the debit points database to create, change, or delete debit points; and
a modify premium content page, whereby a sponsor can modify the premium content database to create, change, or delete premium content.

13. The media disc and environment of claim 1, further comprising a protective sleeve for storage of the media disc, the sleeve having indicia pertaining to a sponsor, home team, or the featured content of the media disc.

14. The media disc and environment of claim 1, the media disc having indicia pertaining to a sponsor, home team, or the featured content of the media disc.

15. A method for creating and maintaining a personalized interactive media disc for media storage and user access to an environment for data compilation and retrieval comprising:
obtaining a sponsor, developer, and at least two users;
providing the personalized interactive media disc for media storage and user access to an environment for data compilation and retrieval, of claim 1;
giving the media disc away at a spectator event by the sponsor and the developer to the user;
inserting the media disc into the user's computer;
presenting animations;
providing a waive liability for viruses option to the user;
checking if user's computer has Internet access;
providing a registration decision to the user;
providing a registration page for the user;
creating a profile for the user;
providing an existing user decision to the user;
storing registration information on the developer's server;
storing premium content on the developer's server; and
storing basic content on the media disc.

16. The method of claim 15, further comprising:
checking the user database for a previously registered disc; and
checking the user database for previously registered user.

17. The method of claim 15, further comprising:
Providing the developer website of claim 11;
entering ID and password on logon page; and
viewing the developer information page.

18. The method of claim 15, further comprising:
providing the administrative module of claim 11;
creating the developer's website page, the promotions page, the credit points database page, the debit points database page, and the premium content page;
changing the developer's website page, the promotions page, the credit points database page, the debit points database page, and the premium content page; and
deleting the developer's website page, the promotions page, the credit points database page, the debit points database page, and the premium content page.
